(19) United States
(12) Patent Application Publication
(10) Pub. No.: US 2011/0151928 A1
(43) Pub. Date: Jun. 23, 2011

(54) METHOD OF AND APPARATUS FOR ACQUIRING AN IMAGE

(76) Inventors: David James Montgomery, Oxford (GB); Benjamin James Hadwen, Oxford (GB); Sunay Shah, Oxford (GB); Tamas Zeffer, Oxford (GB)

(21) Appl. No.: 13/060,438

(22) PCT Filed: Aug. 4, 2009
(86) PCT No.: PCT/JP2009/064096

§ 371 Date: Feb. 24, 2011

(30) Foreign Application Priority Data
Aug. 28, 2008 (GB) 0815619.2

(51) Int. Cl. H04M 1/02; H04N 5/335; H04N 5/225

(52) U.S. Cl. 455/556.1; 348/294; 348/222.1; 348/E05.024; 348/E05.091

(57) ABSTRACT

An apparatus for acquiring an image comprises a display (60), such as an LCD and backlight, for illuminating the object. A photosensor array (61) detects light reflected from the object. A controller (62) causes the display (60) and the photosensor array (61) to: illuminate the object (100); acquire (102) a first image (104) of the object; display a first illuminating pattern (106) for illuminating the object, which first illuminating pattern is derived (108) from the first image; and acquire (102) a second image (110) of the object illuminated by the first illuminating pattern (106). The controller (62) preferably causes the display (60) and the photosensor array (61) to: display a second illuminating pattern (112) for illuminating the object, which second illuminating pattern is derived (108) from at least the second image; and acquire a third image (114) of the object illuminated by the second illuminating pattern (112).

### TECHNICAL FIELD

The present invention relates to a method of and an apparatus for acquiring an image. Such apparatuses may comprise image sensor arrangements incorporated into spatial light modulators, for example, a liquid crystal display with a photodiode located at each pixel. Applications of such techniques include touch panels and scanning and in particular high resolution image acquisition, for example of fingerprints or document information such as text. Such techniques may also be applied to emissive displays with sensors.

### BACKGROUND ART

The use of charge-coupled device (CCD) line sensors for fingerprint scanning is well known in the prior art. For example JP 01119881 (Fujitsu) describes a method utilising a line CCD sensor for acquiring fingerprints.

Methods for placing image sensor arrays in liquid crystal displays are also well known in the prior art. For example, GB2398916 and GB2439098 describe electronic arrangements within an active matrix display that also contains photodiodes. The main application of these displays is in low resolution touch panel sensors.

FIG. 1 of the accompanying drawings illustrates such a system from a top view. Each white pixel, 13, consisting of three coloured pixels, red, 14, green, 15, and blue, 16, contains one photo-sensor, 11, and related control electronics, 12.

FIG. 2 of the accompanying drawings illustrates the light reflection path for the case of a liquid crystal display from a side view in the prior art. A backlight, 22, emits light, 23, through the pixels, 13, to illuminate a target, 21. This target can be a finger, business card etc. The target scatters light backwards, 24, towards the sensors, 11, which form an image of the target.

U.S. Pat. No. 7,009,663 (Planar Systems Inc.) shows an alternative method for the acquisition of images from a phototransistor array within a liquid crystal display.

Prior art describing methods for improving the image resolution in this system is limited.

U.S. Pat. No. 6,243,069 (Matsushita) describes a display with an image sensor array incorporated into it as in the prior art for these systems. The patent also discloses a method for recording an image using a sequence of acquired images where only a small range of photodiodes record data at each sequence image. A complete image is assembled by taking the relevant parts of each image where the photodiodes are activated. The stated advantage of this is reduced noise between the image sensors and the liquid crystal pixels.

WO 2006/098383 (Sharp) discloses another system utilising an image sensor array within a liquid crystal display (LCD), the image sensors being photodiodes. In this system, light from a backlight passes through the liquid crystal display and is reflected from a target. The target is then recorded on the photodiode array by reflected light from the target. The directivity of the light passing through the display is controlled by grouping pixels in a particular manner and recording only an image from another particular group of photodiodes, which may be related to the grouped pixels. Multiple images can then be taken and put together into a final image.

Placing an array of optical sensors such as photodiodes within the pixel structure of a transmissive display such as a liquid crystal display has a number of uses. One primary use is in the detection of the position of one or more fingers on the display, such as is the case in a touch sensitive display. Such displays are well known in the prior art (e.g. R A Quinnell, “Touch screen technology” EDN Nov. 9, 1995), and the use of optical sensors in such displays is described in the above prior art. Touch screen technology requires only a low resolution in its imaging quality in order to determine the finger position. For example, several millimetres in position accuracy are allowed in determining the accuracy of the system.

This technology can be developed into application areas such as fingerprint determination and reading text, for example from a business card as input to optical character recognition (OCR) software. Fingerprint determination can be separated into determining the presence of a fingerprint, that would determine a touch of a part of the screen, and more accurately determining the positional accuracy or recognising the fingerprint for security purposes.

Authentication for fingerprint based security has certain requirements so that software can acquire sufficient information in order to accurately determine whether a print is real or fake. One such specification is the Intel Biometric user Authentication guidelines, November 2005 (version 1.03). These suggest that a resolution of 1251 pi (lines per inch) should be determined on the device at an MTF (modular transfer function) of 33%. A similar requirement is required for OCR of small text on a Japanese business card. This resolution is significantly greater than what is required for touch panels and a normal LCD with typical image sensors cannot achieve this resolution.

The main reason for the low resolution is the glass thickness, 25, (illustrated in FIG. 2) of the glass substrate 20. This glass thickness is also assumed to include polariser and other films on the front surface of an LCD, for example. The physical distance between the sensor layer (typically integral with the thin film transistor (TFT) layer of the LCD) and the target allows light to diffuse, 24. A smaller glass thickness of approximately 0.1 mm is desirable for high resolution applications. However, for an LCD, this typically involves the front LCD glass substrate, a polariser and a protective front cover sheet and these together typically may be 1 mm or more.

Methods for an improvement in resolution have been considered. Optical imaging methods, such as microlens arrays, are difficult because they are very difficult to manufacture and they can degrade the quality of the display, which is undesirable.

Software based methods have been described in the prior art (such as U.S. Pat. No. 6,243,069 and WO2006/098383 above). These do not change the display quality but use a sequence of display images and acquire each image in a different way to assemble a higher resolution image.

FIG. 3 of the accompanying drawings illustrates this method, 37, in general. A number of scans, N, is chosen, 30, and a set of N pixel aperture transmission arrangements for the display are chosen, 31, where the pixels are black (non-transmitting) except for every N-th pixel, which is white (transmitting). The arrangement typically has square symmetry and each pixel is transmitting only once across the set of arrangements. The first arrangement is displayed on the display and an image is recorded, 32, by the sensor array. The photo-sensor data at the pixels where there was a transmitting display pixel only is kept, 35. If the number of images taken is less than N, 33, then the next arrangement in the set is taken where different pixels are now transmitting, 34 and the process is repeated. Once N images are taken, then a final image is assembled, 36.

FIG. 4 of the accompanying drawings illustrates the method for the case where N=4. This illustrates the four displayed pixel transmission arrangements on the display with square symmetry, the first, 31, and the three subsequent images, 34a, 34b and 34c. The illustration shows the transmitting pixels 40, and the non-transmitting pixels, 41. The four sensed images from the photodiodes 35a, 35b, 35c, and 35d are assembled into a final image, 36.

The methods described in these patents have two main problems. First, very thin glass is still required for resolution improvement to the level required for fingerprints. Second, the images are preset and typically involve restriction of light from certain areas of the backlight. In this case, a significantly dimmer image is acquired at each of the positions 35a-35d.

The photodiode structure is typically very small to fit into individual pixels and, for the same reason, the circuitry driving the photodiode directly can only be very simple. Thus, there is a significant problem with noise for low light signals, which limits the brightness that can be calibrated for in the system.

Use of the WO2006/098383 and U.S. Pat. No. 6,243,069 systems is thus limited by the noise level in the images and so greater improvement would involve greater noise levels. Thus, for a given system, the improvement and thus maximum glass thickness is limited.

For example, for a 84 um pitch LCD with one sensor per pitch, 1251 pi can only be obtained for target/sensor distances (glass thickness 25 in FIG. 2) less than 100 um. With the prior art software systems, this can be improved to 250 um. However, this may not be practical as the reduction in brightness caused by the dark pixels in the displayed image means that each sensed image may be too dark to obtain good information.

It is well known that the quality of a captured image, for example a fingerprint image, can be improved by employing standard image processing techniques. Such techniques may be used, for example, to detect edges and/or specific features of interest, to remove noise, to remove spurious features or artefacts from within the image, or reduce blurring effects associated either with motion or with non-focal plane imaging.

These techniques all have in common that their success in solving what is essentially a problem of information recovery depends on the use of available prior information. This prior information may comprise, for example, information regarding noise sources (which can then be removed by smoothing techniques) or information regarding the extent of blurring in an image. An example of the latter would be in the case of a non-focal plane image where some prior knowledge of the distance from the image plane to the sensor plane facilitates the use of de-blurring algorithms. Such geometrical information can be very useful even if it is not known very accurately. Alternatively, de-blurring is possible even without this geometrical information being explicitly available, since the image itself contains certain information regarding the extent to which it is blurred.

Known image processing techniques used specifically for de-blurring are described extensively in the literature and can be found described, for example, in “Deblurring Images: Matrices, Spectra and Filtering (Fundamentals of Algorithms)”, Hansen et al., published by Society for Industrial Mathematics (2007). Useful techniques that my be employed and are described include de-convolution based methods and the use of filters, for example a Wiener filter or Lucy-Richardson filter.

An overview of techniques specific to fingerprint analysis and detection can be found described in “Handbook of Fingerprint Recognition”, Maltoni et al. 2003, ISBN 0-387-95431-7 published by Springer.

Other known methods for creating high resolution images use a sensor element to capture multiple images and then combine these into a final high resolution image. In this way, a final image of higher resolution than is possible with a simple image capture can be recreated. “An Architecture of Compressive Imaging”, Wakin et al. (Proc. International Conference on Image Processing—ICIP 2006, Atlanta, Ga., October, 2006)” describes a digital image/video camera that directly acquires random projections of a scene without first collecting the pixels. The camera architecture employs a digital micromirror array to optically calculate linear projections of the scene onto pseudorandom binary patterns. It is thus able to obtain an image or video with a single detection element (the so-called “single pixel image sensor”).

Many other techniques for combining multiple images into a single final image are also known, for example as in US20090147004. Other examples are given in “Handbook of Image and Video Processing”, Editor Al Bovik, Elsevier Academic Press, Second Edition (2005), ISBN 0-12-119792-1, sections 3.12-3.13, p 297-322, which include “stereo methods”, “mosaicking” and “super-resolution” techniques. A method for combining multiple fingerprint images to produce a single, higher quality fingerprint image is described in “Fingerprint Mosaiking”, Jain A. K. and Ross A., Proc. Int. Conf. on Acoustic Speech and Signal processing, vol. 4, pp 4604-4607, 2002. The combining of multiple images from both the same and multiple different sensors is known. The combination of multiple images to increase the quality of the final image is further known to include the following: calibration of the image sensor (for example to remove pixel-to-pixel photoresponse non-uniformity), the removal of spurious events (such as cosmic rays), assisting techniques of image compression, removing random or fixed pattern noise, combining information obtained by imaging at different wavelengths of illumination, and enhancing resolution.

### SUMMARY OF INVENTION

According to a first aspect of the invention, there is provided an apparatus for acquiring an image of an object, comprising a display arranged to illuminate the object, a photosensor arrangement arranged to detect light from the display reflected by the object so as to acquire the image, and a controller for controlling the display and the photosensor arrangement to perform the steps of:

1) illuminating the object;

2) acquiring a first image of the object;

3) displaying a first illuminating pattern for illuminating the object, which first illuminating pattern is derived from the first image; and

4) acquiring a second image of the object illuminated by the first illuminating pattern.

The display may comprise a two-dimensional array of pixels.

The photosensor arrangement may comprise a two-dimensional array of photosensors. The photosensor arrangement may comprise a two-dimensional array of photosensors and each of the photosensors may be disposed adjacent a respect group of pixels, where each group comprises at least one pixel. Each group may comprise a composite white pixel group of colour component pixels.

The controller may be arranged to control the display to perform the step 1) by displaying a uniform maximum brightness pattern.

The controller may be arranged to control the display and the photosensor to perform the further steps of:

5) displaying a second illuminating pattern for illuminating the object, which second illuminating pattern is derived from at least the second image; and

6) acquiring a third image of the object illuminated by the second illuminating pattern.

The controller may be arranged to control the display and the photosensor arrangement to repeat the steps 5) and 6) with the second illuminating pattern in the or each repeated 5) being derived from at least one image acquired in at least one previously performed acquiring step. The controller may be arranged to repeat the steps 5) and 6) until an image of acceptable quality is acquired. The acceptable quality may comprise a contrast ratio greater than a predetermined threshold. The controller may be arranged to limit the number of acquired images to a predetermined number.

The controller may be arranged to repeat the steps 5) and 6) a predetermined number of times.

In the or each step 5), the second illuminating pattern may be the image acquired in the immediately preceding step 4) or 6).

The controller may be arranged to process at least one image, acquired in at least one previously performed acquiring step, to form the second illuminating pattern for the or each step 5).

The display may comprise a two-dimensional array of pixels and the controller may be arranged to process the previously acquired image such that the or each image pixel having a brightness greater than or equal to a first value is assigned a maximum value, the or each image pixel having a brightness less than or equal to a second value is assigned a minimum value, and the or each image pixel having a brightness between the first and second values is assigned an intermediate value scaled according to a predetermined function between the maximum and minimum values. The controller may be arranged to multiply each pixel brightness of the acquired image by the assigned value of the corresponding pixel of the previously acquired image for display during a succeeding image acquisition. The controller may be arranged to add a predetermined value to each assigned value and to limit the assigned values to the maximum value.

The display and the photosensor arrangement may each comprise a two-dimensional array of pixels and the controller may be arranged to derive each pixel of the second illuminating pattern from a plurality of pixels of the or each previously acquired image. The controller may be arranged to process the or each previously acquired image in the spatial domain. The controller may be arranged to form the spatial derivative of the or each previously acquired image. The controller may be arranged to process the or each previously acquired image in the frequency domain.

The controller may be arranged to invert the brightness of the at least one previously acquired image.

The controller may be arranged to process at least the third image acquired in the, or the last, step 6) to provide a final image. The controller may be arranged to process the first image to provide the final image. The controller may be arranged to process all of the acquired images to provide the final image. The controller may be arranged to derive the low frequency spatial content of the final image from at least one earlier of the acquired images and the high frequency spatial content of the final image from at least one later of the acquired images.

The controller may be arranged to control the display and the photosensor arrangement: to perform the or each step 5) as a plurality of sub-steps of illuminating the object with the second illuminating pattern in different colours; and, in the or each step 6), to acquire the third image by combining images formed by illumination by the different colours.

The controller may be arranged to control the display to display a plurality of interlaced fields of each of the first and second illuminating patterns in sequence and to assemble corresponding acquired interlaced image fields into the second and third acquired images.

The display may comprise an at least partially transmissive spatial light modulator and a backlight. The spatial light modulator may comprise a liquid crystal device.

According to a second aspect of the invention, there is provided an image manipulating system comprising an apparatus according to the first aspect of the invention and a writable memory arranged to store each image acquired by the apparatus.

According to the third aspect of the invention, there is provided an image manipulating system comprising an apparatus according to the first aspect of the invention and a readable memory containing stored images.

At least one of the writable memory and the readable memory may be disposed within the apparatus.

The system may comprise a processor arranged to compare an acquired image with a stored image and to provide an indication of similarity therebetween.

The system may comprise a portable device including the apparatus and arranged to be enabled when the processor provides an indication of similarity greater than a predetermined degree of similarity. The portable device may be a mobile telephone.

The stored images may comprise fingerprint images.

According to a fourth aspect of the invention, there is provided an image processing system comprising an apparatus according to the first aspect of the invention and a character recognition arrangement for recognising text characters in an image acquired by the apparatus.

The arrangement may be arranged to convert the or each recognised character to electronic form.

The controller may be arranged to control the display to display the or each recognised character.

According to a fifth aspect of the invention, there is provided a method of acquiring an image of an object, comprising:

illuminating the object;

acquiring a first image of the object;

displaying a first illuminating pattern for illuminating the object, which first illuminating pattern is derived from the first image;

acquiring a second image of the object illuminated by the first illuminating pattern.

It is thus possible to provide techniques, using a simple software and scanning based approach, which improve the required maximum sensor/target distance or resolution but without significantly changing the brightness of the image and hence the sensitivity of the display. The requirements for sensitivity and noise may be much improved for this system of scanning as compared with previous systems. Such a method, when combined with known methods, may give greater improvement in glass thickness for a given sensitivity of the detectors. The greater glass thickness adds mechanical strength to the system and is easier to process during manufacture. Complex and inaccurate image processing techniques such as edge detection, image recognition etc. are not required.

### BRIEF DESCRIPTION OF DRAWINGS

FIG. 1 shows a known sensor arrangement within a pixel;

FIG. 2 illustrates the light paths for a typical known touch sensor or fingerprint display;

FIG. 3 illustrates a known method of improving the resolution of a sensor in a display;

FIG. 4 illustrates a particular example of the method of FIG. 3, where N=4;

FIG. 5 illustrates a method constituting an embodiment of the invention;

FIG. 6 shows an apparatus constituting an embodiment of the invention;

FIG. 7 illustrates an example of image processing performed by the method of FIG. 5;

FIG. 8 illustrates another example of image processing performed by the method of FIG. 5;

FIG. 9 illustrates another method constituting an embodiment of the invention;

FIGS. 10 to 13 illustrate methods of image processing constituting further embodiments of the invention; and

FIGS. 14 and 15 show apparatuses constituting further embodiments of the invention.

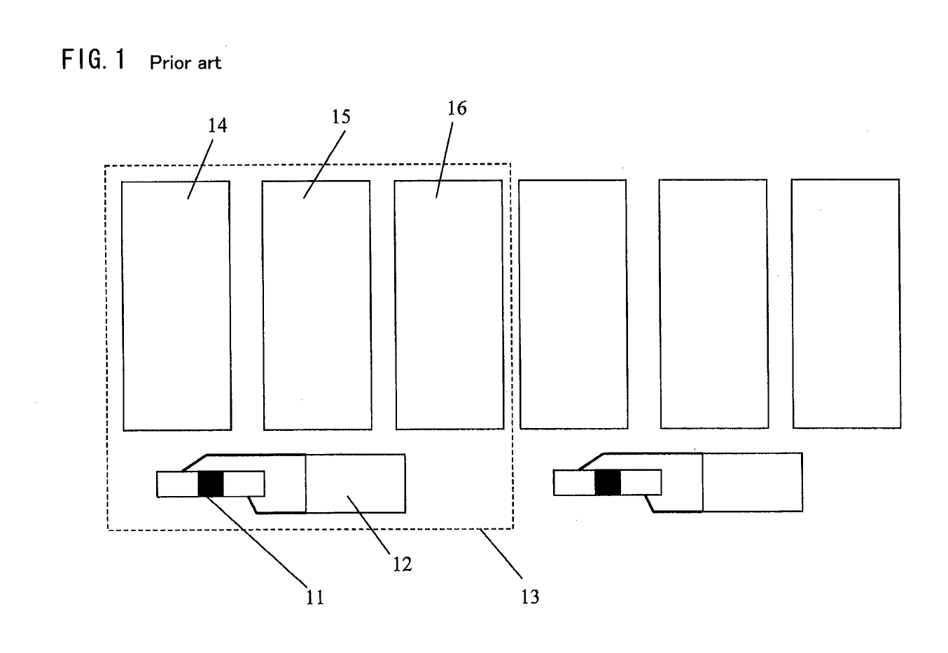

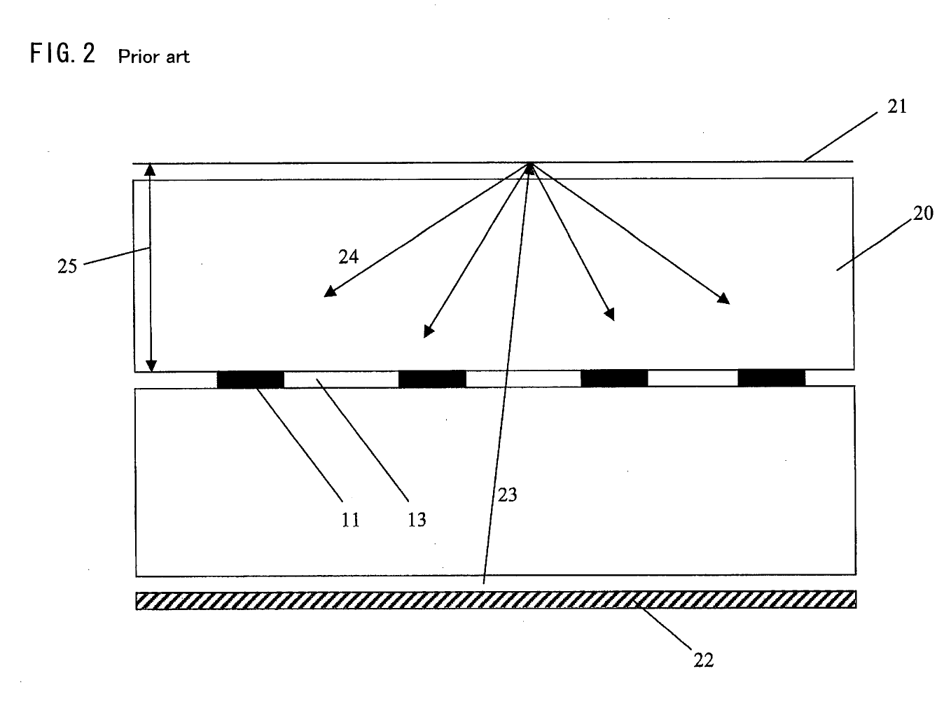

### DESCRIPTION OF EMBODIMENTS

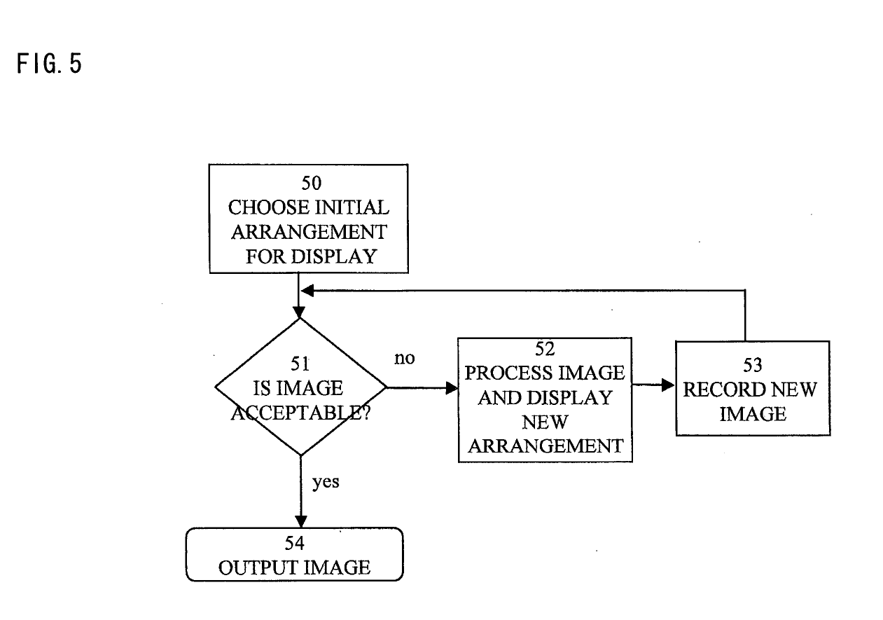

A method constituting an embodiment of the invention is shown in FIG. 5. An initial display pixel (or non-pixellated) transmission (or emission) arrangement is chosen, 50, which may be such that all the pixels are transmitting so as to provide a uniform maximum brightness pattern. A sensed image is recorded and a decision whether the image is good enough is made, 51. Alternatively, the decision step 51 may be based on whether a predetermined number (for example three) of cycles have been completed. If not, the sensed image is processed into a new pixel transmission arrangement, for example by taking the transmission of the pixels as the brightness of each element in the detected image from the photosensors, and displayed on the display, 52. A new sensed image is recorded, 53. If this image is good enough, then this is output as a final image, 54.

One example of this is where the first displayed image is a white screen (all pixels transmitting). A sensed image is captured and then displayed directly on the screen for a second capture and this continues until a sufficiently high resolution image results, a contrast ratio greater than a predetermined threshold is achieved, or a counter counts down a (predetermined) number of reinforcement cycles.

The sensitivity requirement of the sensors is now much improved, as most of the pixels are now only dark where the target itself is dark.

Such a method may be used with any suitable display incorporating a sensor arrangement. For example, the display may comprise an at least partially transmissive spatial light modulator (such as a liquid crystal device) and a backlight or an emissive display that has photo-sensors integrated into it in a regular order that is correlated to the pixel pattern. The display may be a liquid crystal display (LCD) and the photo-sensors may be photodiodes or phototransistors. The display may comprise a two dimensional array of pixels arranged as groups, each of which may comprise a composite white pixel group. The photo sensors may be arranged as a two dimensional array with each photosensor being disposed adjacent a respective group of pixels.

The pixel transmission arrangement is an example of an illuminating pattern which may be used with a transmissive display such as an LCD, which is normally pixellated. However, illuminating patterns may be displayed on types of displays other than transmissive, such as emissive as mentioned above, and on displays which are pixellated or non-pixellated. On non-pixellated displays, the pattern may be pixellated or non-pixellated as convenient or in accordance with requirements.

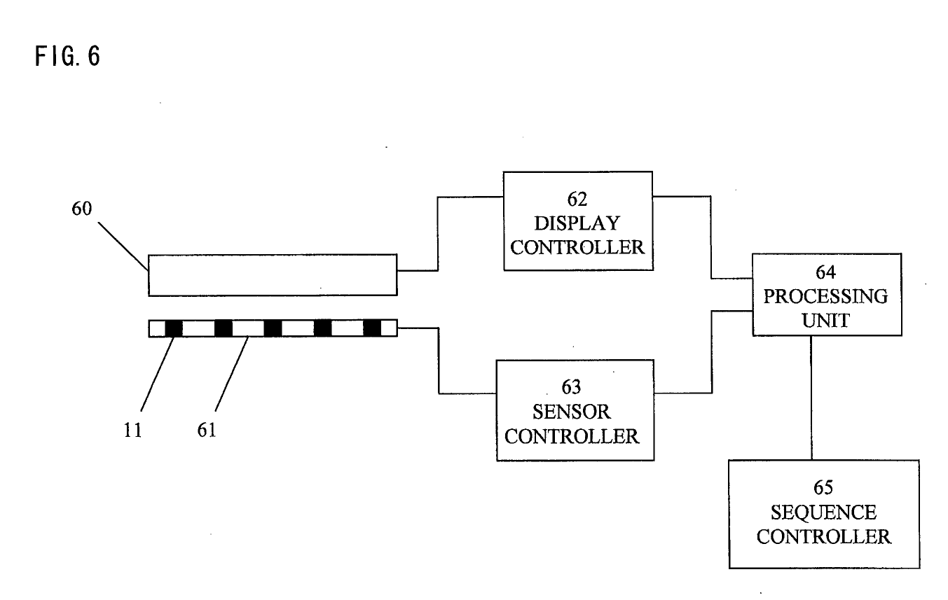

In FIG. 6, the display, 60, is controlled by a display controller, 62, for example of a known type, and the photo-sensor array, 61, is controlled by a controller, 63, for example of known type. The images recorded by the photo-sensor array are processed by a processing unit, 64, that then sends the result to the display controller, 62, for display on the display.

The processing unit, 64, also has a sequence controller, 65, for example of known type, that arranges a sequence of image acquisitions while the pixel transmission arrangement on the display is as processed from previous images. The sequence controller, 65, also determines when sufficient contrast has been obtained in the image to complete the image acquisition.

The first image on the display in the sequence may be a fully transmitting image (e.g. full white screen).

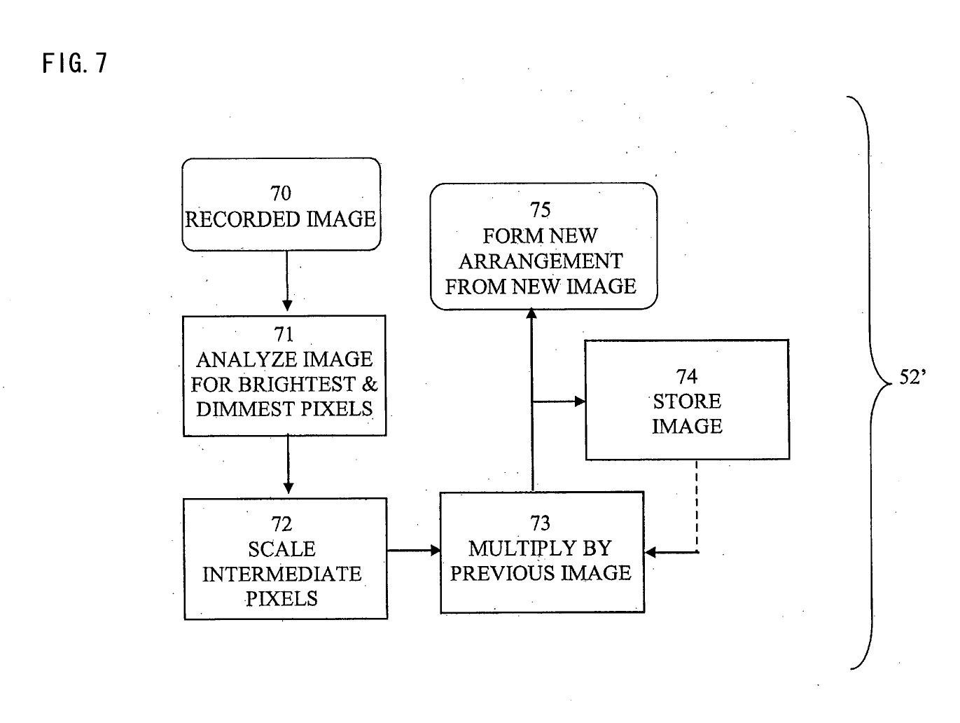

FIG. 7 shows a detail of the image processing, 52′, used in the preferred embodiment. Each recorded image, 70, from the image sensor controller, 63, is analysed to determine the “brightest” pixel (pixel recording the highest light level) and the “dimmest” pixel (pixel recording the lowest light level), 71. The brightest pixel is then given a maximum value such as 1 and the dimmest a minimum value such as 0. All intermediate values are scaled according to a predetermined function, for example linearly, between the maximum and minimum values 1 and 0, 72. The number at each sensed pixel is then multiplied by the corresponding displayed image pixel value in the previous image, 73, thus forming a new image, 75, which is stored for the next sequence, 74.

This technique makes dimmer areas more dim and lighter areas more light. Thus, in each sequence, a greater contrast is acquired in an image through this “positive reinforcement” and this greater resolution.

Techniques for noise reduction in the image such as ignoring a number of very bright or very dim pixels or pixel areas can be used to determine the brightest and dimmest levels. These brightest parts can be made equal to 1, and the dimmest parts to 0.

The relationship of the other pixel values to a level between 1 and 0 may not be a linear relation but any arbitrary relation, for example a gamma curve relationship where the value of gamma is present or calculated from the data. Gamma curves are known for compensating for non-linear relationships between a display signal input and light output, and will not be further described.

The conversion may not be a straight multiplication. For example, a small known quantity or predetermined value may also be added to each image point and all pixels brighter than are scaled back to 1. In an alternative example, the brightest pixel may be scaled to a value larger than 1, for example 1.2, optionally followed by addition of the small quantity, followed by setting to 1 any pixel with a resulting value greater than 1 (or by any other suitable processing). This will prevent the bright areas becoming slowly dimmer over time.

The process of capturing a fresh image while displaying a (processed) previously captured image may be repeated until an image of “acceptable quality” has been captured. Alternatively, (or additionally to limit the number of iterations), a predetermined number of image-captures may be performed. For example, a known number of iterations of a sequence that will achieve a required result, e.g. 1251 pi for a fingerprint scan, will be sufficient.

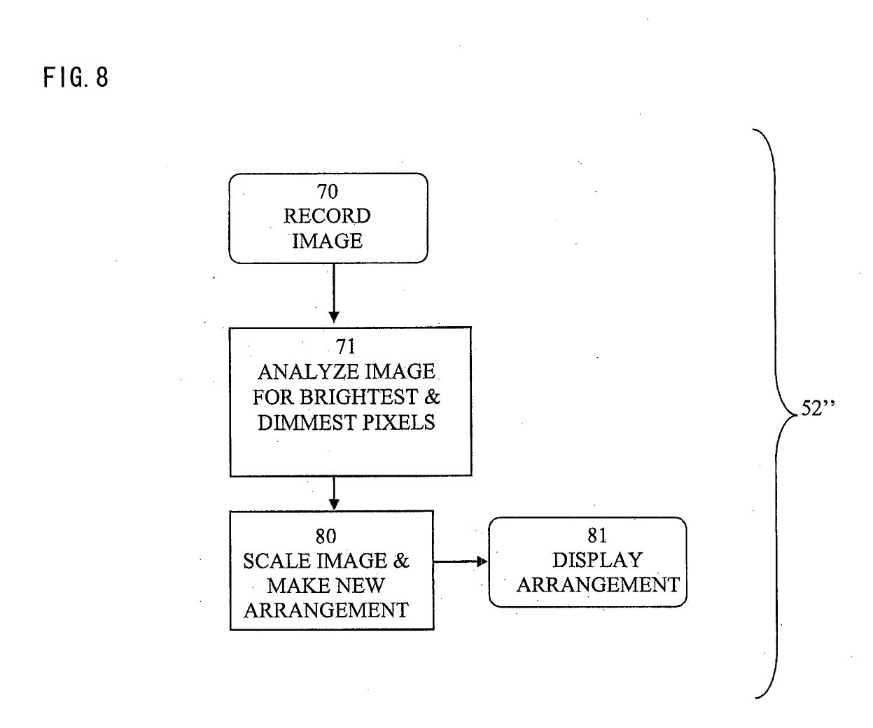

There is another form of image processing 52″ that can be used. In FIG. 8, the processing steps, 70 and 71 are the same as described hereinbefore. The brightest and dimmest pixels, 71, are determined from the input image, 70, then scaled to the appropriate level for image display, 80 and this image is used directly for the pixel transmission arrangement in the next sequence, 81. The same modifications can be added to this procedure as the former procedure.

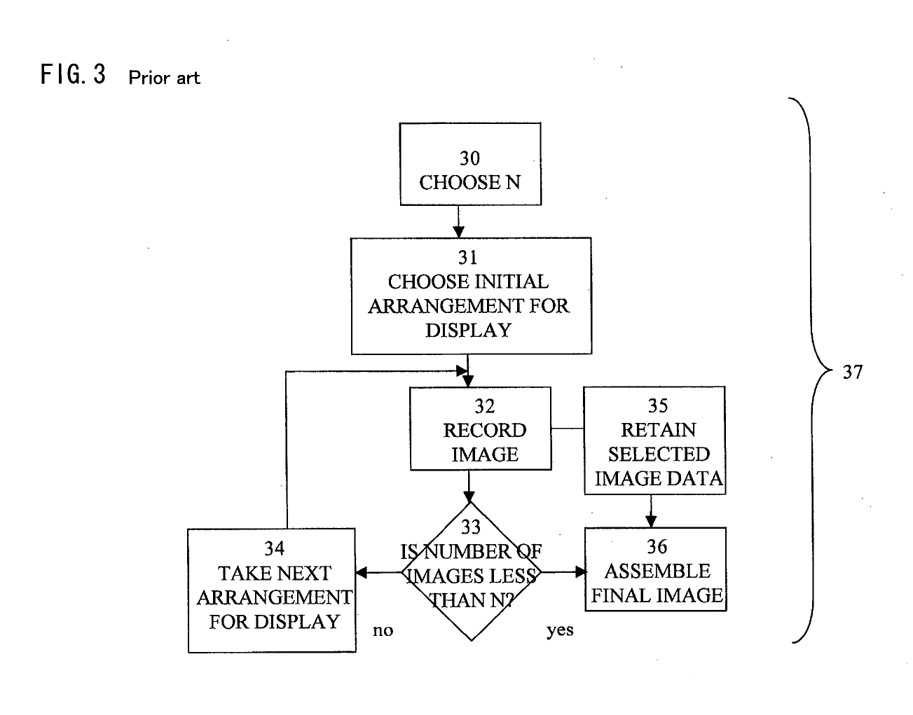

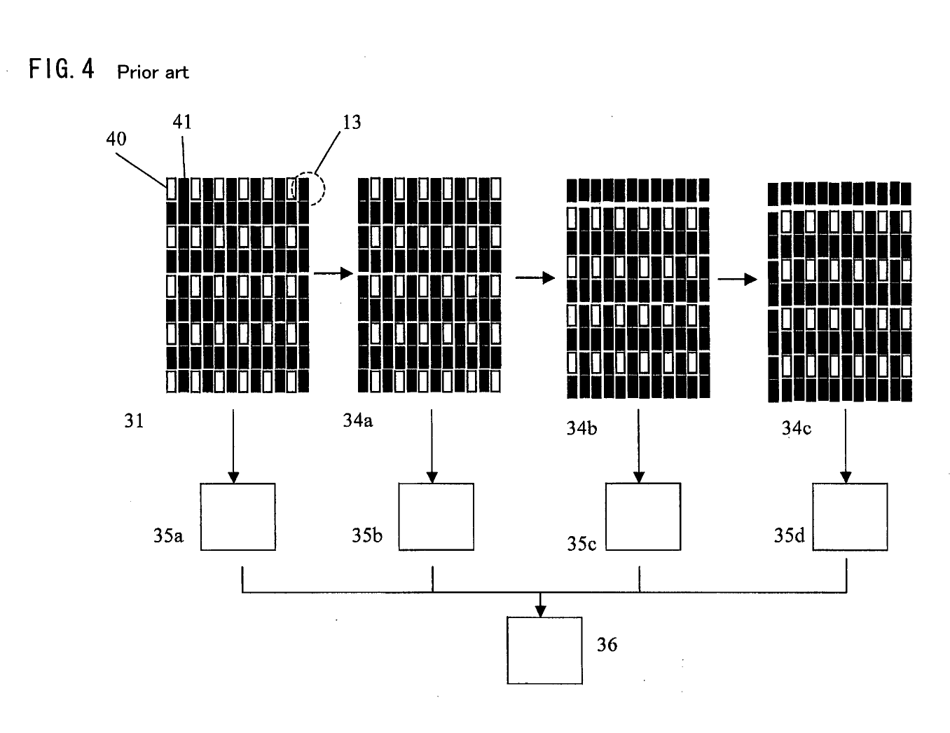

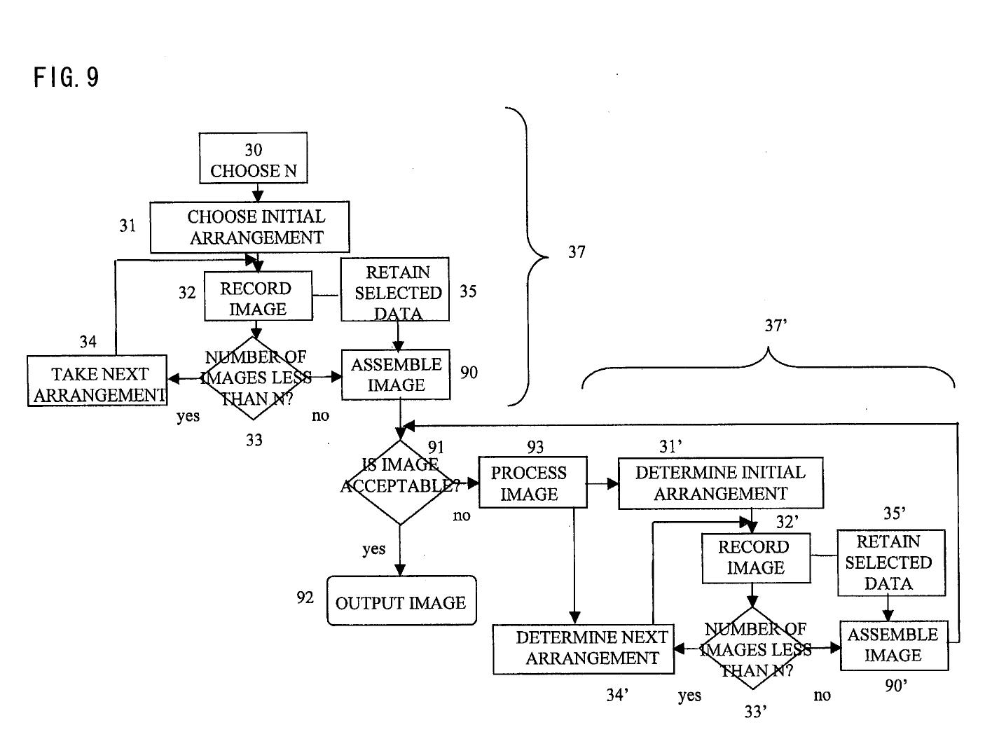

In an additional embodiment illustrated in FIG. 9, the known type of fixed image sequence scan 37 as described hereinbefore with reference to FIG. 3 is modified to incorporate the present technique. In this case, the known scan sequence is performed, 37, and an image acquired, 90. This image then forms the basis of another scan sequence 37′ of the same type in which the “black” pixels are still black but the white pixels are replaced by the corresponding pixel values determined in the previous scan sequence. In each of the scan sequences 37 and 37′, interlaced fields of the illuminating pattern are displayed in sequence and the corresponding acquired interlaced image fields are assembled into the acquired image.

The image acquired in the first scan, 90, (by the steps 30 to 35 as described hereinbefore) is checked to see if it is good enough, 91, and if so, it is output, 92. If not, the image is processed according the methods described hereinbefore, 93, and the corresponding image pixel values are used in place of the “white” transmitting pixels in a new scan 37′, that consists of steps 31′ to 35′ identical to steps 31 to 35, respectively of the scan 37, but with the modification of the transmitting pixel values. The output of this step, 90′ is checked for quality at step 91 and, if necessary, is processed, 93, and the scan, 37′ is repeated with updated transmitting pixel values. This continues until a known number of repetitions is complete or a high quality image results, 92.

The use of the known scanning technique may require an increase in the sensitivity of the sensors. However, the use of the present technique generally reduces the number of scans needed for the same improvement as with the prior art alone.

These techniques may be used with image sensor arrangements that have one sensor at each white pixel. Thus the display images and detected images may be greyscale images. In principle, it is possible to provide a colour image arrangement, whereby three sensors (e.g. for red, green and blue data) or more are contained within a single composite pixel (for example comprising colour component pixels) of a display. In this case, all previously described embodiments may be applied separately and individually for the red, green and blue (or more) components of the image.

The following embodiments may also include one or more of the features described in the previous embodiments, for example non-linear multiplicative scaling of the sensor images to give the subsequent image to be displayed, or ignoring the brightest and dimmest levels in the sensor image when performing the processing.

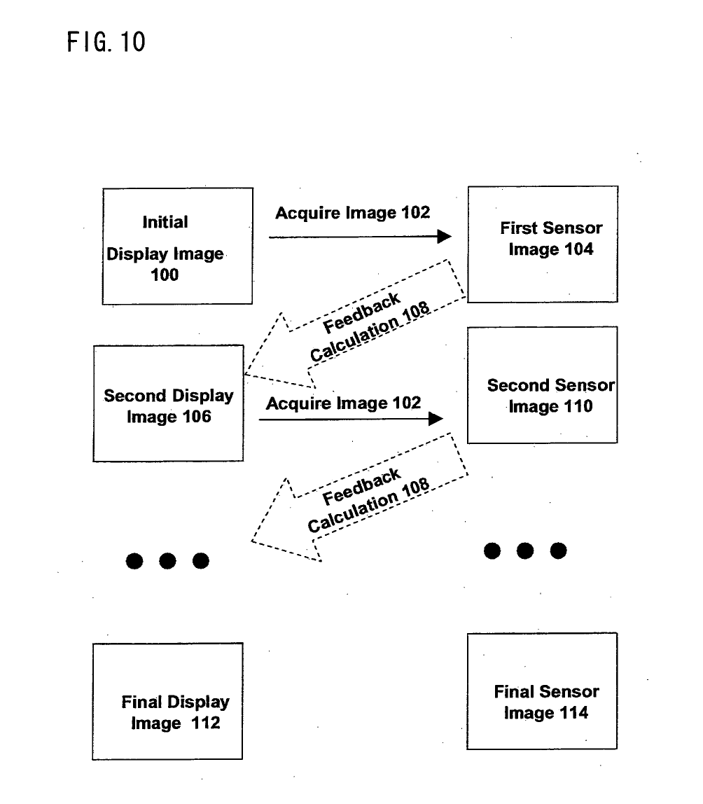

Another embodiment of the invention is shown in FIG. 10. The operation of this embodiment is as follows.
An initial pattern is placed upon the display 100.
The image sensor is configured to capture and record 102 a first sensor image 104.
A calculation step 108 is performed to calculate the second display image 106 as a predefined function of the first sensor image 104.
The second display image 106 is placed upon the display and a second sensor image 110 is captured and recorded.
A pre-specified number of further iterations are carried out to calculate a final display image 112 to capture and record a final sensor image 114.

This embodiment differs from those previously described in that each calculation step 108 is defined explicitly such that the calculated intensity of a given pixel (x, y) of the second display image 106 is a function of all of the pixels of the first sensor image 104 (and not just the pixel (x, y) of the first sensor image 104.

The calculation step 108 is thus an image processing step which may comprise one or more known techniques. Examples include:
Algebraic image processing techniques in the spatial domain, e.g. noise reduction by smoothing, score based assessment.
Algebraic image processing techniques in the frequency domain, performed by transforming (for example Fourier transforming) the first sensor image 104, performing a processing operation in the frequency domain, then transforming the result back to the spatial domain.
Differentiation of the sensor image such that edge features in the sensor image correspond to regions of a high level of illumination in the subsequent display image.
Inversion of the sensor image such that bright features in the sensor image 104 correspond to dark features in the subsequent display image 108, and dark features in the sensor image 104 correspond to bright features in the subsequent display image 108.

An advantage of this embodiment is that the techniques of image processing may be used to feedback an optimised image to the display, and thus improve the resolution of the final image. A further advantage of this embodiment is that image processing techniques may be used to remove unwanted noise and/or image artefacts and/or distortion from the captured sensor image prior to feedback to the display image.

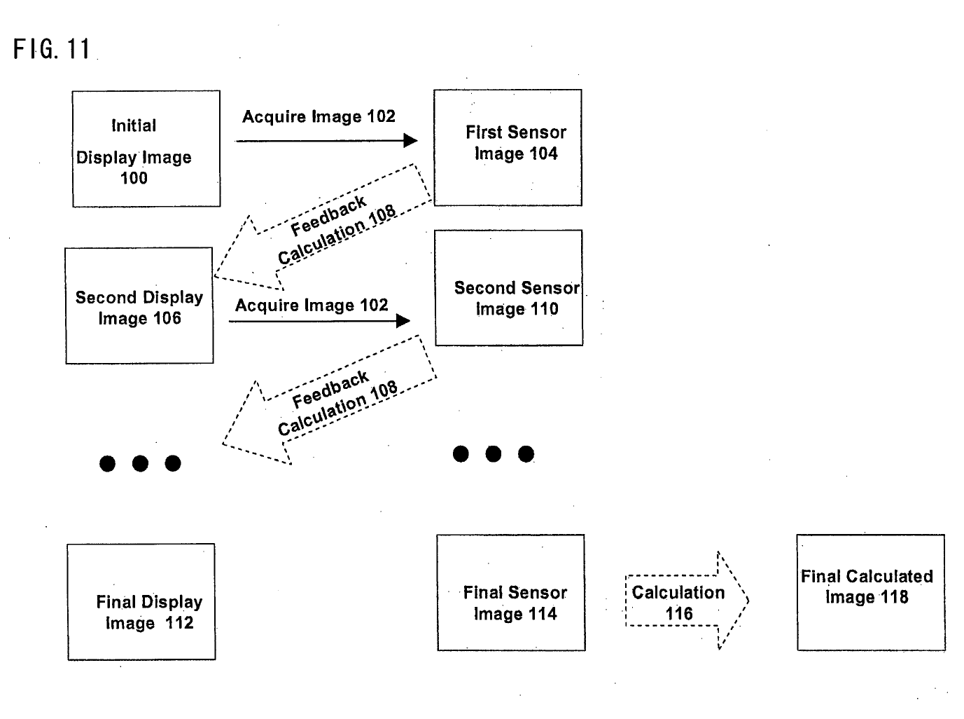

A further embodiment is shown in FIG. 11. This embodiment is as the previous embodiment with the following additional step.
The final calculated image 118 is calculated from the final sensor image 114, by means of calculation step 116.

The calculation step 116 is an image processing technique which may invoke one or more standard methods as has already been described.

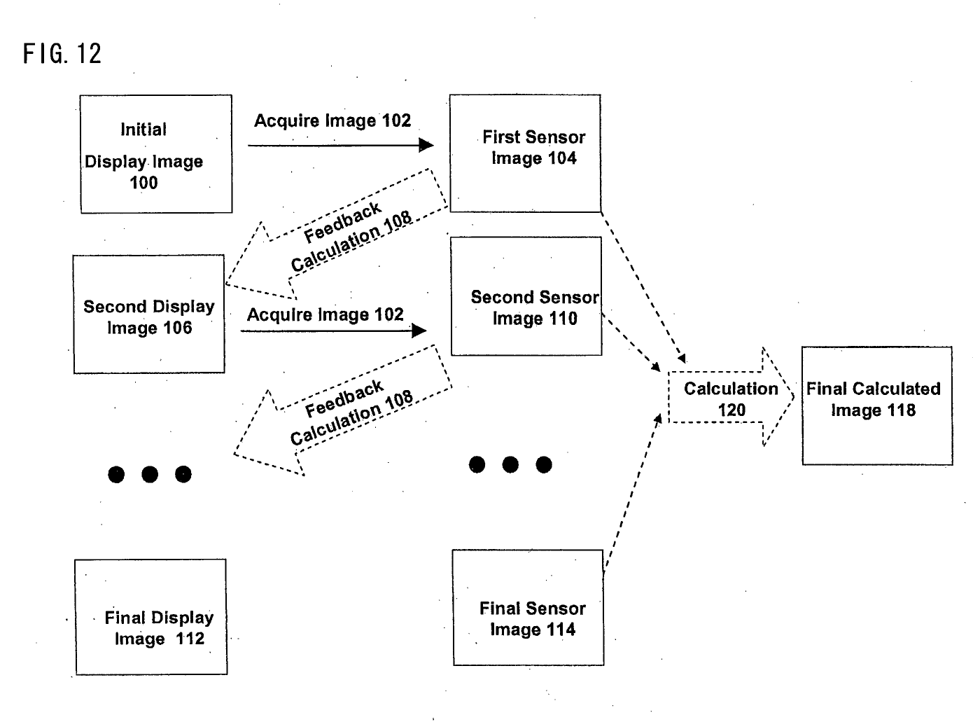

Another embodiment is shown in FIG. 12. This embodiment is as the previous embodiment, except that the final calculated image 118 is calculated as a function of all the acquired sensor images (104, 110, 114). The calculation step 118 may utilise one or more of several known methods for combining multiple images to obtain a single final image with desirable features (for example enhanced resolution, reduced noise).

Examples of processing techniques that may be utilised to combine multiple sensor images include, but are not restricted to, the following which are described in the prior art:
Mosaicking techniques
Super-resolution techniques

An extension of this method is that the image combination technique may make specific use of the sequence in which the sensor images are obtained. For example, the sensor images from earlier iterations may be used to determine content at low spatial frequencies, whilst the sensor images from later images may be used to determine image content at higher spatial frequencies.

An advantage of this embodiment is that the final calculated image is able to make use of additional information in comparison to the previous embodiment. A further advantage is that any non-idealities such as noise, artefacts or image distortion introduced by the iterative process may be removed in the calculation of the final image (since such non-idealities are not present in the first sensor image 104).

In an alternative embodiment, the calculation step 120 to determine the display image as a function of the previous sensor image contains a pseudo-random component. The technique thus resembles that used by the single-pixel image sensor disclosed in “An Architecture for Compressive Imaging, Wakin et al. (Proc. International Conference on Image Processing—ICIP 2006, Atlanta, Ga., October 2006)” as already described, with the additional refinement that the calculated display image is merely pseudo-random, and not entirely random. Whilst containing some random component, this calculated image may also contain additional content calculated using image processing techniques described in previous embodiments, such as that illustrated in FIG. 10.

An advantage of this embodiment over the prior art method of the single-pixel image sensor is that the additional information incorporated in the feedback technique may be used to optimise the method such that a fewer number of iterations may be used to achieve a given resolution compared to a truly random method.

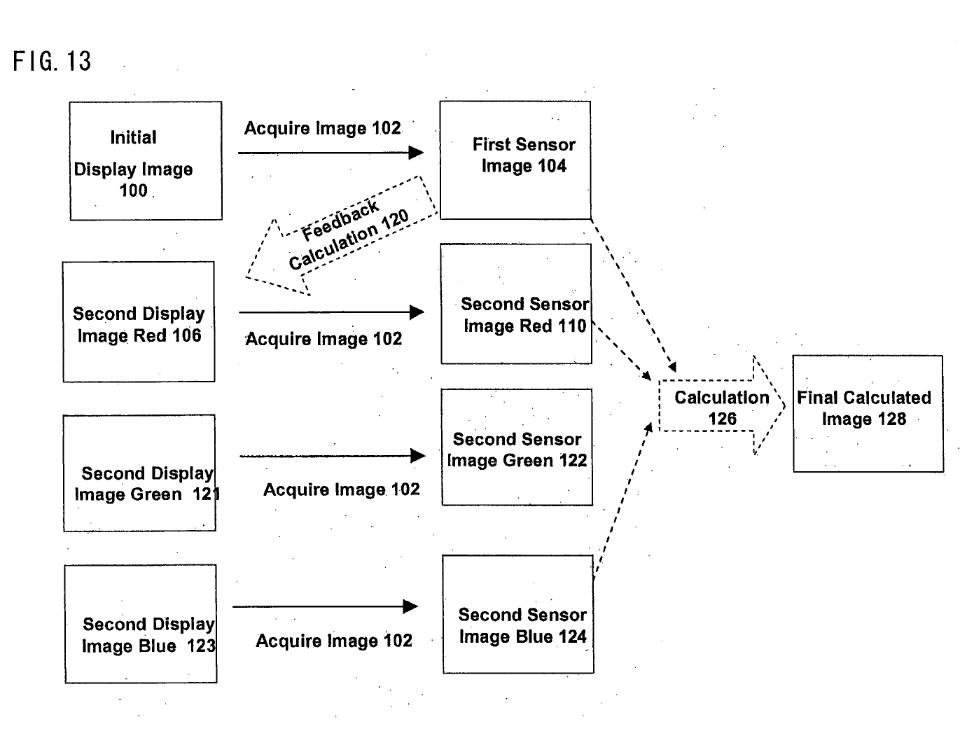

A further embodiment as shown in FIG. 13 may use the techniques of any of the previous embodiments, where for each iteration three separate sensor images 110, 122, 124, are captured. These three images are obtained with the display pattern set to display the calculated 126 pattern firstly in the red channel only 106, second in the green channel only 121 and thirdly in the blue channel only 123. The sensor image 128 for each iteration is then obtained by combining the three sensor images obtained with red, green and blue display patterns according to a known image combination technique.

An advantage of this embodiment is that imaging in the red, green and blue channels separately can provide additional information regarding the content of the target being imaged, including the resolution. This advantage is on account of two factors:
Firstly the propagation of red, green and blue wavelengths of light through the optical system may be different and known to be different, so image processing techniques for de-blurring may be optimised separately for the red, green and blue images.
Secondly, the positions of the red, green and blue colour channels in the display are offset from each other by a known fraction of a pixel (typically ⅓ of a pixel). By considering the spatial shift between the red, green and blue sensor images, and the different spatial information contained within them, additional information regarding the spatial content of the images can be obtained and utilised in the recreation of the final calculated image 128.

In the case of a display comprising an at least partially transmissive spatial light modulation and a backlight, as well as modulating the pattern set on the display, the intensity of the backlight may also be modulated for different feedback iterations. Also, the backlight illumination source may have additional controllable features which are varied during the iterative image capture process. Examples include:
Illumination of the backlight such that only some of the backlight LEDs are lit.
Controllable illumination having a directional dependence.

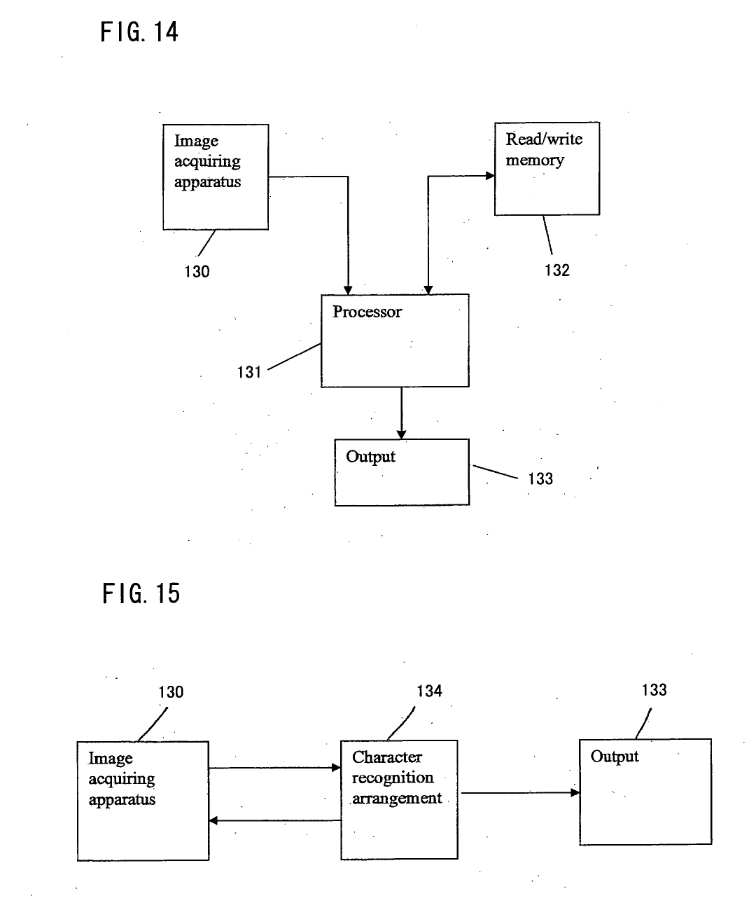

FIG. 14 illustrates an image manipulating system comprising an image acquiring apparatus 130 in accordance with any of the embodiments described hereinbefore. The images acquired by the apparatus 130 are supplied to a processor 131 provided with a read/write memory 132 and an output 133. The processor 131, the memory 132 and the output 133 may, together with the apparatus 130, form part of a portable device, such as a mobile or cellular telephone. As an alternative, the memory 132, and possibly also the processor 131 and the output 133, may be located remotely from the apparatus 130 and may communicate with it via any suitable communication path. For example, the memory 132 and part or all of the processor 131 may communicate with the apparatus 130 by means of an internet connection or the like.

The apparatus 130 may be used to acquire images of fingerprints. Such images are acquired as described hereinbefore and each image is then supplied to the processor 131. The processor 131 forwards each image to the memory 132, which acts as a write memory so as to provide a database of fingerprints. Alternatively or additionally, the memory 132 may be provided with a database containing fingerprints from other sources.

The system shown in FIG. 14 may be used to recognise fingerprints by comparing images of fingerprints acquired by the apparatus with fingerprints stored in the memory 132, for which purpose the memory 132 acts as a read memory. The system may act as a verification system, for example by authenticating the identity of a person by comparing a scanned fingerprint acquired by the apparatus 130 with biometric characteristics of a fingerprint stored in the memory 132. The system may alternatively or additionally recognise an individual by searching the fingerprint database stored in the memory 132 for a match with a scanned fingerprint. When verification or identification is achieved, for example when the processor 131 compares an acquired image of a fingerprint with a stored image and provides an indication of similarity greater than a predetermined degree of similarity, a suitable response is generated by the output 133. For example, the response may comprise enabling the system to perform other functions. In the case of a mobile telephone, such enabling may provide unlocking of the telephone for use.

Techniques for comparing fingerprint images for verification or identification are known. For example, Minutiae-based techniques are based on identifying the position of fingerprint minutiae, such as loops, whorls and bifurcations. Example of such techniques are disclosed in “Minutiae-based Fingerprint Matching Using Subset Combination” Sha et al, Proceeding of the 18th Conference on Patent Recognition, Vol. 4, pp 566-569. Other methods include those based on calculating correlations between two images. Examples of techniques are also disclosed in “Handbook of Fingerprint Recognition”, Maltoni et al, published by Springer Science 2003, ISBN 0-387-95431-7.

FIG. 15 illustrates another image processing system using or incorporating an image acquiring apparatus 130 according to any of the embodiments described hereinbefore. The apparatus 130 communicates with a character recognition arrangement 134, which is provided with an output 133. This system may be used for scanning text, such as a business card in the case of an apparatus incorporated in a mobile telephone, and for storing an electronic version of the text characters in a memory within the arrangement 134 for supply via the output 133. For example, the stored text characters may be downloaded to a remote database via the output 133. The characters recognised by the arrangement 134 may also be displayed by the display within the apparatus 130, for example for checking or amendment.

The character recognition arrangement 134 may perform any suitable method for recognising text and text characters, whether printed or handwritten, using any appropriate techniques. Examples of known techniques for this purpose are known from convention Optical Character Recognition (OCR) techniques. Examples of such technique are disclosed in “Handbook of Image and Video Processing”, edited by Al Bovik, Elsevier Academic Press, Second Edition (2005), ISBN 0-12-119792-1.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. An apparatus for acquiring an image of an object, comprising a display arranged to illuminate the object, a photosensor arrangement arranged to detect light from the display reflected by the object so as to acquire the image, and a controller for controlling the display and the photosensor arrangement to perform the steps of:
1) illuminating the object;
2) acquiring a first image of the object;
3) displaying a first illuminating pattern for illuminating the object, which first illuminating pattern is derived from the first image; and
4) acquiring a second image of the object illuminated by the first illuminating pattern.

2. An apparatus as claimed in claim 1, in which the display comprises a two-dimensional array of pixels.

3. An apparatus as claimed in claim 1, in which the photosensor arrangement comprises a two-dimensional array of photosensors.

4. An apparatus as claimed in claim 2, in which the photosensor arrangement comprises a two-dimensional array of photosensors and each of the photosensors is disposed adjacent a respective group of pixels, where each group comprises at least one pixel.

5. An apparatus as claimed in claim 4, in which each group comprises a composite white pixel group of colour component pixels.

6. An apparatus, as claimed in claim 1, in which the controller is arranged to control the display to perform the step 1) by displaying a uniform maximum brightness pattern.

7. An apparatus as claimed in claim 1, in which the controller is arranged to control the display and the photosensor arrangement to perform the further steps of:
5) displaying a second illuminating pattern for illuminating the object, which second illumination pattern is derived from at least the second image; and
6) acquiring a third image of the object illuminated by the second illuminating pattern.

8. An apparatus as claimed in claim 7, in which the controller is arranged to control the display and the photosensor arrangement to repeat the steps 5) and 6) with the second illuminating pattern in the or each repeated step 5) being derived from at least one image acquired in at least one previously performed acquiring step.

9. An apparatus as claimed in claim 8, in which the controller is arranged to repeat the steps 5) and 6) until an image of acceptable quality is acquired.

10. An apparatus as claimed in claim 9, in which the acceptable quality comprises a contrast ratio greater than a predetermined threshold.

11. An apparatus as claimed in claim 9, in which the controller is arranged to limit the number of acquired images to a predetermined number.

12. An apparatus as claimed in claims 8, in which the controller is arranged to repeat the steps 5) and 6) a predetermined number of times.

13. An apparatus as claimed in claim 7, in which, in the or each step 5), the second illuminating pattern is the image acquired in the immediately preceding step 4) or 6).

14. Apparatus as claimed in claim 7, in which the controller is arranged to process at least one image, acquired in at least one previously performed acquiring step, to form the second illuminating pattern for the or each step 5).

15. An apparatus as claimed in claim 14, in which the display comprises a two-dimensional array of pixels and the controller is arranged to process the previously acquired image such that the or each image pixel having a brightness greater than or equal to a first value is assigned a maximum value, the or each image pixel having a brightness less than or equal to a second value is assigned a minimum value, and the or each image pixel having a brightness between the first and second values is assigned an intermediate value scaled according to a predetermined function between the maximum and minimum values.

16. An apparatus as claimed in claim 15, in which the controller is arranged to multiply each pixel brightness of the acquired image by the assigned value of the corresponding pixel of the previously acquired image for display during a succeeding image acquisition.

17. An apparatus as claimed in claim 15, in which the controller is arranged to add a predetermined value to each assigned value and to limit the assigned values to the maximum value.

18. An apparatus as claimed in claim 14, in which each of the display and the photosensor arrangement each comprises a two-dimensional array of pixels and the controller is arranged to derive each pixel of the second illuminating pattern from a plurality of pixels of the or each previously acquired image.

19. An apparatus as claimed in claim 18, in which the controller is arranged to process the or each previously acquired image in the spatial domain.

20. An apparatus as claimed in claim 19, in which the controller is arranged to form the spatial derivative of the or each previously acquired image.

21. An apparatus as claimed in claim 18, in which the controller is arranged to process the or each previously acquired image in the frequency domain.

22. An apparatus as claimed in claim 14, in which the controller is arranged to invert the brightness of the at least one previously acquired image.

23. An apparatus as claimed in claim 7, in which the controller is arranged to process at least the third image acquired in the, or the last, step 6) to provide a final image.

24. An apparatus as claimed in claim 23, in which the controller is arranged to process the first image to provide the final image.

25. An apparatus as claimed in claim 24, in which the controller is arranged to process all of the acquired images to provide the final image.

26. An apparatus as claimed, in claim 24, in which the controller is arranged to derive the low frequency spatial content of the final image from at least one earlier of the acquired images and the high frequency spatial content of the final image from at least one later of the acquired images.

27. An apparatus as claimed in claim 7, in which the controller is arranged to control the display and the photosensor arrangement: to perform the or each step 5) as a plurality of sub-steps of illuminating the object with the second illuminating pattern in different colours; and, in the or each step 6), to acquire the third image by combining images formed by illumination by the different colours.

28. An apparatus as claimed in claim 7, in which the controller is arranged to control the display to display a plurality of interlaced fields of each of the first and second illuminating patterns in sequence and to assemble corresponding acquired interlaced image fields into the second and third acquired images.

29. An apparatus as claimed in claim 1, in which the display comprises an at least partially transmissive spatial light modulator and a backlight.

30. An apparatus as claimed in claim 29, in which the spatial light modulator comprises a liquid crystal device.

31. An image manipulating system comprising an apparatus as claimed in claim 1 and a writable memory arranged to store each image acquired by the apparatus.

32. An image manipulating system comprising an apparatus as claimed in claim 1 and a readable memory containing stored images.

33. A system as claimed in claim 31, in which at least one of the writable memory and the readable memory is disposed within the apparatus.

34. A system as claimed in claim 31, comprising a processor arranged to compare an acquired image with a stored image and to provide an indication of similarity therebetween.

35. A system as claimed in claim 34, comprising a portable device including the apparatus and arranged to be enabled when the processor provides an indication of similarity greater than a predetermined degree of similarity.

36. A system as claimed in claim 35, in which the portable device is a mobile telephone.

37. A system as claimed in claim 31, in which the stored images comprise fingerprint images.

38. An image processing system comprising an apparatus as claimed in claim 1 and a character recognition arrangement for recognising text characters in an image acquired by the apparatus.

39. A system as claimed in claim 38, in which the arrangement is arranged to convert the or each recognised character to electronic form.

40. A system as claimed in claim 38, in which the controller is arranged to control the display to display the or each recognised character.

41. A method of acquiring an image of an object, comprising;
illuminating the object;
acquiring a first image of the object;
displaying a first illuminating pattern for illuminating the object, which first illuminating pattern is derived from the first image; and
acquiring a second image of the object illuminated by the first illuminating pattern.
